(19) United States
(12) Patent Application Publication
(10) Pub. No.: US 2021/0191623 A1
(43) Pub. Date: Jun. 24, 2021

(54) STORAGE SYSTEM

(71) Applicant: Hitachi, Ltd., Tokyo (JP)

(72) Inventors: Ryosuke Tatsumi, Tokyo (JP); Naruki Kurata, Tokyo (JP)

(73) Assignee: Hitachi, Ltd., Tokyo (JP)

(21) Appl. No.: 17/012,308

(22) Filed: Sep. 4, 2020

(30) Foreign Application Priority Data
Dec. 20, 2019 (JP) 2019-229906

(51) Int. Cl. G06F 3/06

(52) U.S. Cl. CPC G06F 3/0611; G06F 3/0653; G06F 3/0658; G06F 3/0683; G06F 3/0665; G06F 3/0635; G06F 3/0659

(57) ABSTRACT

To improve the performance of storage systems.

A plurality of controllers monitor a transfer amount of each path of a plurality of host paths and a plurality of drive paths in a logical volume; estimate changes of a host path and a drive path after a change of the priority of the plurality of host paths, and estimate the transfer amount of each path of the plurality of host paths and the plurality of drive paths after the change of the priority on a basis of the estimated changes of the host path and the drive path, and the monitored transfer amount of each path; and change the priority of the plurality of host paths on a basis of the estimated transfer amount of each path such that the transfer amount of each path satisfies a predetermined condition.

### CLAIM OF PRIORITY

The present application claims priority from Japanese patent application JP 2019-229906 filed on Dec. 20, 2019, the content of which is hereby incorporated by reference into this application.

### BACKGROUND OF THE INVENTION

### 1. Field of the Invention

The present invention relates to a storage system.

### 2. Description of the Related Art

Typical storage systems include a plurality of controllers, and processors in the controllers control data input and output (I/O) to and from a drive in accordance with an I/O request received from a host computer. There is network connection between each one of the controllers and the host computer, between the controllers, and between each one of the controllers and the drive.

There are storage systems that allocate processors to be responsible for I/O processes for each logical volume in order to execute the I/O processes efficiently. Some of such storage systems include a plurality of controllers, and a processor of each controller is directly linked with a host interface (I/F), a backend interface for connection with a drive, and a main storage memory. Furthermore, the plurality of controllers are connected to each other by an internal bus.

In such a storage system, the I/O process procedures and data paths of the processors vary depending on which processors the backend interface to be used are physically connected to, and this affects the data access latency and throughput. In one example case, a backend interface of a controller other than a controller including a host interface that has received a read request is used to transfer read-target data from a drive to a main storage memory of the target controller. In this case, it is necessary to transfer the target data to the main storage memory of the controller including the host interface that has received the read request, and transfer the target data from the main storage memory to a host computer. For convenience, such storage systems are referred to as multi-controller storage systems.

PCT Patent Publication No. WO2015/056301 discloses a method in which a backend interface of a controller including a host interface that has received a read request is used to transfer read-target data to a main storage memory of the target controller, in order to remove overhead due to inter-controller data transfer.

In addition, PCT Patent Publication No. WO2016/013116 discloses a method for a multi-controller storage system in which method the priority of paths between a host and a storage system is decided in accordance with differences in inter-controller communication performance.

Multi-controller storage systems use different backend interfaces depending on which host interfaces are used for access. On the other hand, load balancing for each controller changes the responsible processor of each logical volume on the basis of the operation rates (processing loads) of processors responsible for I/O processes.

However, there are various workloads on a storage system. There are workloads with large processing loads on processors, but with small data amounts, and conversely there are workloads with small processing loads on processors, but with large data amounts. As a result, even if the responsible processor of each logical volume is changed on the basis of processing loads on processors, this does not necessarily lead to even processing loads on host interfaces and backend interfaces. Accordingly, some paths become a bottleneck, and the performance of the storage system may deteriorate.

### SUMMARY OF THE INVENTION

One aspect of the present invention is a storage system that processes an I/O request from a host, the storage system including: a plurality of controllers; and a plurality of storage drives. In the storage system, the host and the plurality of controllers are connected to each other by a plurality of host paths, and the plurality of controllers and the plurality of storage drives are connected to each other by a plurality of drive paths. Further, in the storage system, a controller responsible for a logical volume processes an I/O request specifying the logical volume, and a host path and a drive path from the host to a storage drive including a physical storage area related to the logical volume are decided for the controller responsible for the logical volume, host path priority for the logical volume, and the storage drive. Furthermore, in the storage system, the plurality of controllers monitor a transfer amount of each path of the plurality of host paths and the plurality of drive paths in the logical volume, estimate changes of the host path and the drive path after a change of the priority of the plurality of host paths and estimate the transfer amount of each path of the plurality of host paths and the plurality of drive paths after the change of the priority on a basis of the estimated changes of the host path and the drive path, and the monitored transfer amount of each path, and change the priority of the plurality of host paths on a basis of the estimated transfer amount of each path such that the transfer amount of each path satisfies a predetermined condition.

According to one aspect of the present invention, the performance of a storage system can be improved.

Problems, configurations and effects other than those described above become apparent through the following explanation of execution forms.

### BRIEF DESCRIPTION OF THE DRAWINGS

FIG. 1 is a figure illustrating a configuration example of an entire computer system in a first execution example;

FIG. 2A illustrates an area configuration in a memory in the first execution example;

FIG. 2B illustrates a program that is stored in a program storage area in the first execution example, and is to be executed by a processor;

FIG. 2C illustrates a configuration example of control information stored in a control information storage area 132000 in the first execution example;

FIG. 2D illustrates the configuration of a cache memory area in the first execution example;

FIG. 2E illustrates the configuration of a data transfer buffer area in the first execution example;

FIG. 3A is a figure illustrating one example of effects of levelling of the transfer amounts of drive paths in the first execution example;

FIG. 3B is a figure illustrating the one example of the effects of levelling of the transfer amounts of drive paths in the first execution example;

FIG. 4 is a figure illustrating a logical-volume-address management table in the first execution example;

FIG. 5 is a figure illustrating a host-path-priority management table in the first execution example;

FIG. 6 is a figure illustrating an ownership management table in the first execution example;

FIG. 7 is a figure illustrating a path management table in the first execution example;

FIG. 8 is a figure illustrating a path-transfer-amount management table in the first execution example;

FIG. 9 is a figure illustrating a path unit-time transfer-amount management table in the first execution example;

FIG. 10 is a figure illustrating a path unit-time total-transfer-amount management table in the first execution example;

FIG. 11 is a figure illustrating an I/O command management table in the first execution example;

FIG. 12 is a figure illustrating an I/O command processing request message in the first execution example;

FIG. 13 illustrates a cache segment management table in the first execution example;

FIG. 14 is a flowchart of a command assignment process in the first execution example;

FIG. 15A is a flowchart of an I/O process in a first embodiment;

FIG. 15B is a flowchart of the I/O process in the first embodiment;

FIG. 15C is a flowchart of the I/O process in the first embodiment;

FIG. 16 is a flowchart of a path-transfer-amount monitoring process in the first execution example;

FIG. 17 is a flowchart of a priority-host-path selection process in the first execution example;

FIG. 18 is a figure illustrating a configuration example of the entire computer system in a second execution example;

FIG. 19A is a figure illustrating one example of a data transfer amount computing method of each path when host path priority is switched in the second execution example; and

FIG. 19B is a figure illustrating the one example of the data transfer amount computing method of each path when the host path priority is switched in the second execution example.

### DESCRIPTION OF THE PREFERRED EMBODIMENTS

In the following, execution examples of the present disclosure are explained with reference to the attached drawings. Although processes are explained as being performed by a “program” in some cases in the following explanation, since the program is executed by a processor to thereby perform specified processes by using a storage section, an interface section and/or the like as appropriate, the processes may be considered as being performed by the processor (or a device like a controller having the processor).

The program may be installed on an apparatus like a computer from a program source. The program source may be a recording medium (e.g. a non-transitory recording medium) from which a program distribution server or a computer can read out the program, for example. In addition, in the following explanation, two or more programs may be realized as one program, or one program may be realized as two or more programs.

In the following explanation, an expression like “xxx table” is used to explain information obtained as an output in response to an input in some cases, but the information may be data with any structure. In addition, the configuration of each table in the following explanation is one example. One table may be divided into two or more tables, or whole or part of two or more tables may be one table.

The following description explains a method of controlling selection of a path between a storage system and a host in a storage system including a plurality of controllers that control logical volumes (multi-controller storage system). For each logical volume, the storage system monitors which path I/O data has been transferred through.

The storage system estimates how the transfer amount of each host path (frontend path) and drive path (backend path) will change if a path through which I/O data passes is changed when the priority of host paths for each logical volume is changed. From combinations for which transfer amounts have been estimated, the storage system determines a combination with which the transfer amounts of a host path and a drive path satisfy a predetermined condition, and changes the host path priority between the storage system and the host such that the combination is to be used.

As mentioned above, an imbalance among the data transfer amounts of the host and drive paths is reduced in accordance with an I/O access pattern of each logical volume, and a bottleneck in I/O throughputs is overcome.

### First Execution Example

A first execution example is explained with reference to the drawings. Note that execution examples explained below do not limit the invention according to the claims, and all the combinations of features explained in the execution examples are not necessarily essential for solutions of the present invention.

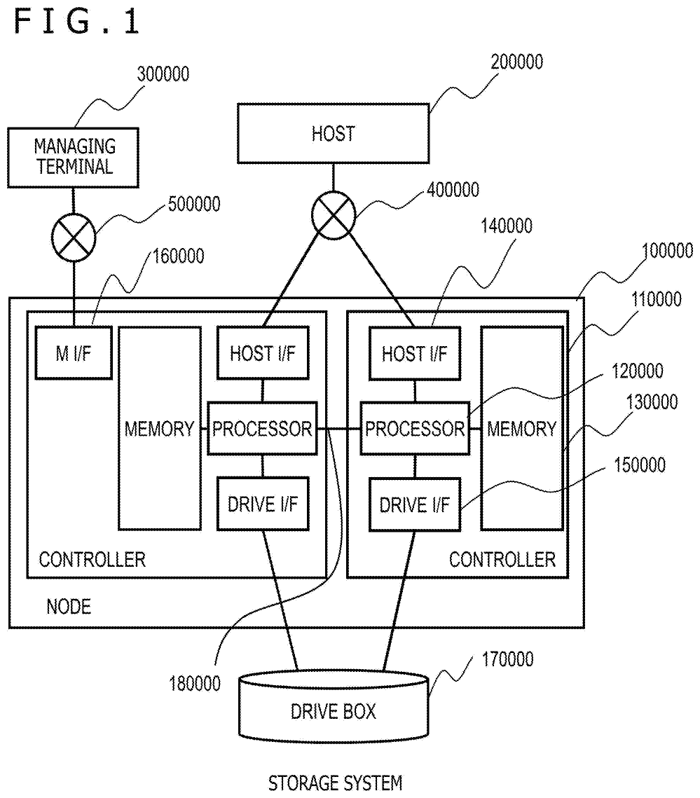

FIG. 1 is a figure illustrating a configuration example of a computer system in a first execution example. The computer system includes a storage system 100000, a host computer 200000 and a managing terminal 300000, and an external network 400000 and a management network 500000 that connect them with each other. FIG. 1 illustrates one storage system 100000, one host computer 200000 and one managing terminal 300000, but their numbers may be any numbers.

The storage system 100000 includes a plurality of storage controllers (hereinafter, also referred to as controllers) 110000. Each controller 110000 includes one or more microprocessor (hereinafter, also referred to as processors) 120000, one or more memories 130000, one or more host interfaces (frontend interfaces) 140000, one or more drive interfaces (backend interfaces) 150000 and one or more management interfaces 160000.

The plurality of controllers 110000 are connected to each other by an inter-controller path 180000, and can each access memories 130000 of other controllers 110000 by the processor 120000, an unillustrated direct memory access (DMA) circuit or the like. The number of controllers is two in the following explanation in order to simplify the explanation, but the number of controllers may be three or greater. In a case where a processor is a multicore processor, several cores in the processor may be treated as a group, and the processor may be logically managed as a plurality of processors.

The host interfaces 140000 are connected to the host computer 200000 through the external network 400000 such as a storage area network (SAN). The management interfaces 160000 are connected to the managing terminal 300000 through the management network 500000 such as a local area network (LAN). The external network 400000 and the management network 500000 can be any networks as long as they comply with protocols that enable data communication.

The storage system 100000 includes: a drive box 170000 that stores a plurality of storage drives (hereinafter, also referred to as drives or storage devices); and the drive interfaces 150000 that connect the drives with the controllers 110000.

The drives may be hard disk drives (HDDs), solid state drives (SSDs), tape-type storage devices and the like. The plurality of drives can form logical volumes on the basis of physical storage areas of one or more drives, and provide the logical volumes to the controllers 110000.

The plurality of drives may form a redundant-array-of-independent-disks (RAID) group for redundancy, and the logical volumes may be provided from the RAID group. The Logical volumes can be provided as logical units (LUs) to the host computer 200000, and can receive write requests and read requests for addresses specified by the host computer 200000. Note that, for each logical volume, one processor 120000 is set as being responsible for I/O processes of the logical volume.

A path that passes through a host interface 140000, and is connected to a host is referred to as a host path, and a path that passes through a drive interface 150000, and is connected to a drive is referred to as a drive path. The host computer 200000 can access an LU via a plurality of host paths. An attribute and the access priority such as active/passive and asymmetric logical unit access (ALUA) can be set for each path.

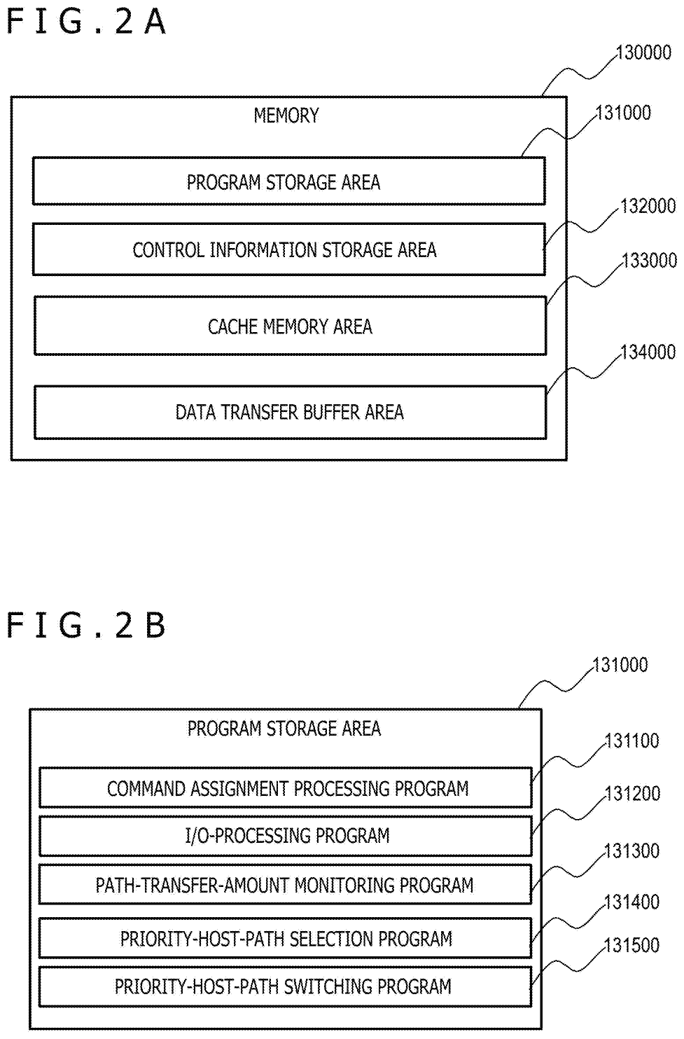

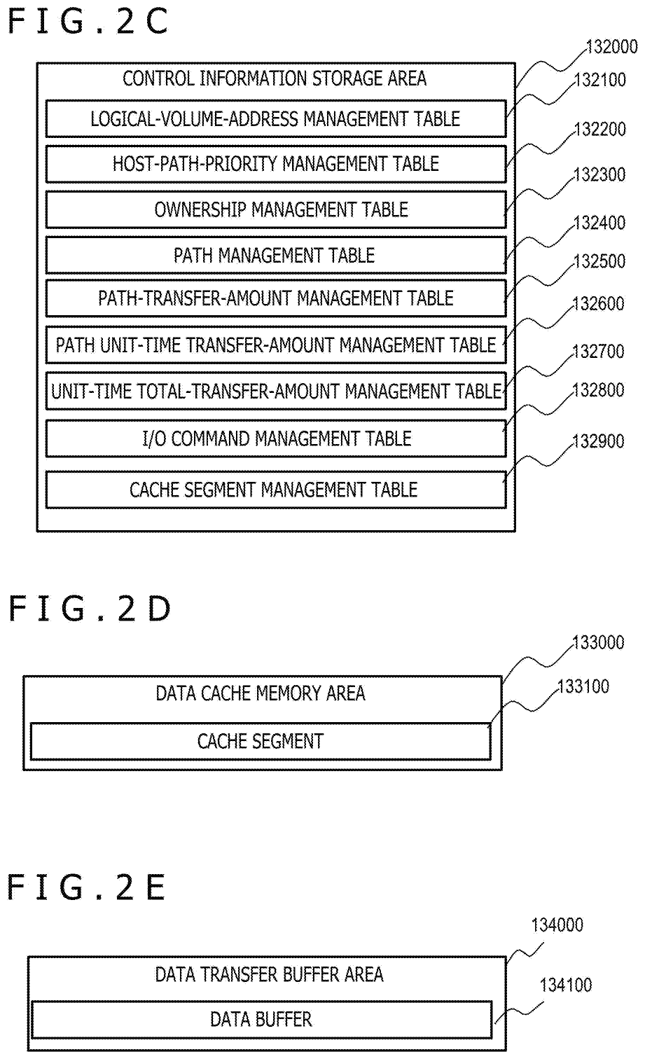

FIG. 2A to FIG. 2E are figures illustrating the logical configuration of a memory 130000. FIG. 2A illustrates the area configuration in the memory 130000. The memory 130000 includes a program storage area 131000, a control information storage area 132000, a cache memory area 133000, a data transfer buffer area 134000 and a cache memory area 135000. In the memory 130000, a cache memory area is reserved for each processor as an area available to the processor.

FIG. 2B illustrates a program that is stored in the program storage area 131000, and is to be executed by the processor 120000. A command assignment processing program 131100 assigns read/write requests received from the host computer 200000 to a processor responsible for I/O processes of a read/write target logical volume. The processor responsible for I/O processes executes read/write processes on target areas in accordance with an I/O-processing program 131200.

A path-transfer-amount monitoring program 131300 monitors and tabulates the transfer amounts of host paths and drive paths. Based on the results of the tabulation, a priority-host-path selection program 131400 predicts the load on each host path and drive path that will result from a change of host path priority (transfer amount prediction), and decides the priority of each host path such that the combination of loads satisfies a predetermined condition.

A priority-host-path switching program 131500 notifies the host computer 200000 the host path priority decided by the priority-host-path selection program 131400. In accordance with the notification of the priority, the host computer 200000 resets the host path priority in itself.

FIG. 2C illustrates a configuration example of control information stored in the control information storage area 132000. The control information storage area 132000 stores a logical-volume-address management table 132100, a host-path-priority management table 132200, an ownership management table 132300, a path management table 132400, a path-transfer-amount management table 132500, a path unit-time transfer-amount management table 132600, a unit-time total-transfer-amount management table 132700, an I/O command management table 132800 and a cache segment management table 132900. Details of these tables are mentioned below.

FIG. 2D illustrates the configuration of the cache memory area 133000, which includes a cache segment 133100. FIG. 2E illustrates the configuration of the data transfer buffer area 134000, which includes a data buffer area 134100.

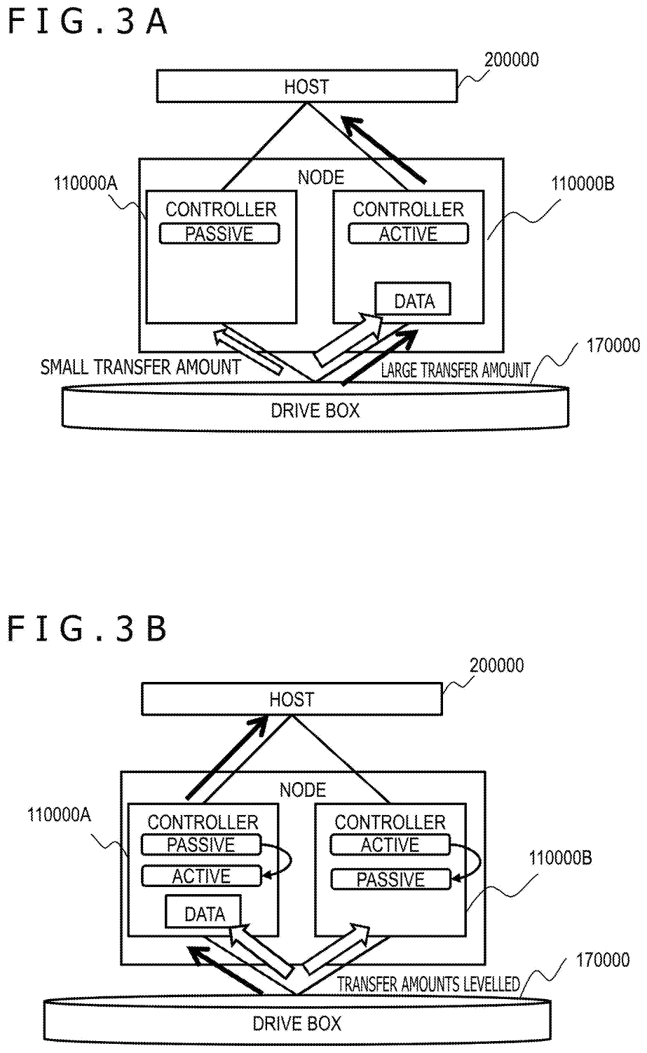

FIG. 3A and FIG. 3B illustrate an example of levelling of the transfer amounts of host paths and drive paths by changing host path priority according to this execution example. In the state illustrated in FIG. 3A, the host path priority of a controller 110000B for a logical volume is set to Active, and the host path priority of a controller 110000A for the logical volume is set to Passive. The host path whose priority is set to Passive is used in a case where the host path whose priority is set to Active cannot be used. A drive path to be used between the host computer and the logical volume is determined in accordance with a host path to be used therebetween.

There is an imbalance of drive path transfer amount between the controller 110000A and the controller 110000B, and the drive path transfer amount of the controller 110000B is greater than the drive path transfer amount of the controller 110000A. At this time, the drive path of the controller 110000B becomes a bottleneck, and the performance of the entire storage system deteriorates.

FIG. 3B illustrates a state in which Active paths of several logical volumes have been changed from the controller 110000B to the controller 110000A, and an I/O request is issued to the storage system in a pattern similar to that in FIG. 3A. The drive path transfer amounts of the controller 110000A and the controller 110000B are levelled, and the bottleneck is overcome. Thereby, the performance of the entire storage system can be improved.

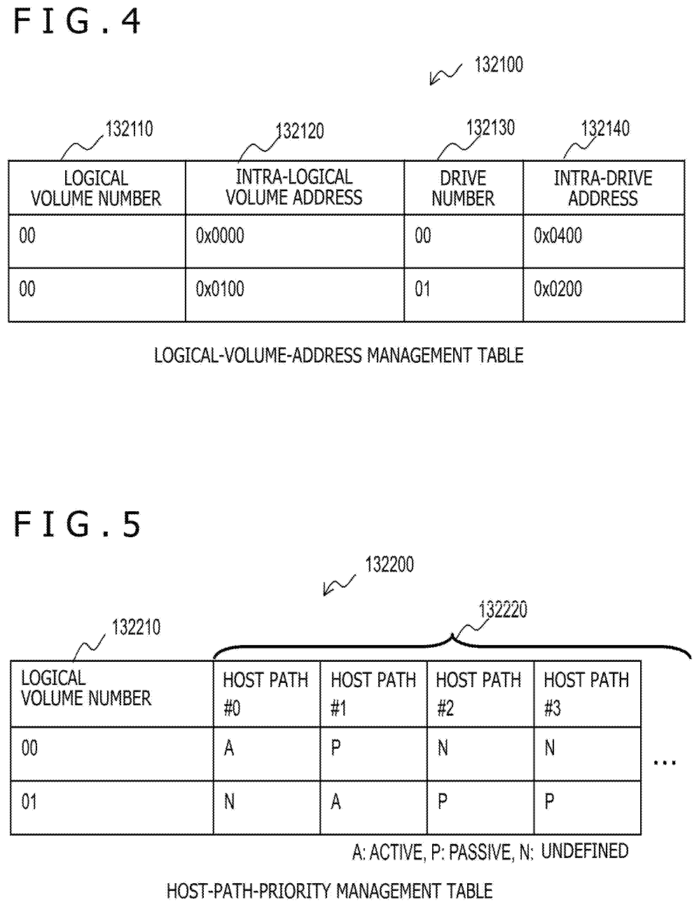

FIG. 4 is a figure illustrating a configuration example of the logical-volume-address management table 132100. The logical-volume-address management table 132100 associates a logical volume number 132110, an intra-logical volume address 132120, a drive number 132130 and an intra-drive address 132140 with each other.

The logical volume number 132110 is a number for identifying a logical volume. The intra-logical volume address 132120 is a number for identifying an address in the logical volume. The drive number 132130 indicates a drive number. The intra-drive address 132140 indicates an address in the drive. By using the logical-volume-address management table 132100, a drive to be accessed, and an address in the drive can be calculated from a logical volume and an intra-logical volume address.

FIG. 5 is a figure illustrating a configuration example of the host-path-priority management table 132200. The host-path-priority management table 132200 associates a logical volume number 132210 and priority information 132220 of each host path with each other. The logical volume number 132210 is a number for identifying a logical volume.

The priority information 132220 of host paths indicates the priority of each host path implemented in the storage system. Although the host path priority is expressed by Active and Passive in this execution example, in the ALUA protocol of SCSI, host path priority is expressed by four types, which are Active/Optimized, Active/Non-Optimized, Standby and Unavailable.

For combinations of logical volumes, host paths and the priority of the host paths, a host path and a drive path from a host to a drive including a physical storage area of a logical volume are decided. In addition, from combinations of a logical volume and the priority of a plurality of host paths of one host computer, the ratio of the data transfer amount of each of the host paths for the logical volume can be estimated. In this manner, changes of the host path and the drive path after a change of the priority of a plurality of host paths are estimated, and, on the basis of the transfer amounts of the host paths and the drive paths being monitored, the ratio of the data transfer amount of each of the host paths for the logical volume is estimated.

Note that any names of priority, and any number of types of priority can be used. In addition, for each logical volume, there may be a plurality of host paths of the same priority between a host and the logical volume, and there may not be a path of certain priority. By using the host-path-priority management table 132200, the priority of each host path can be decided for each logical volume.

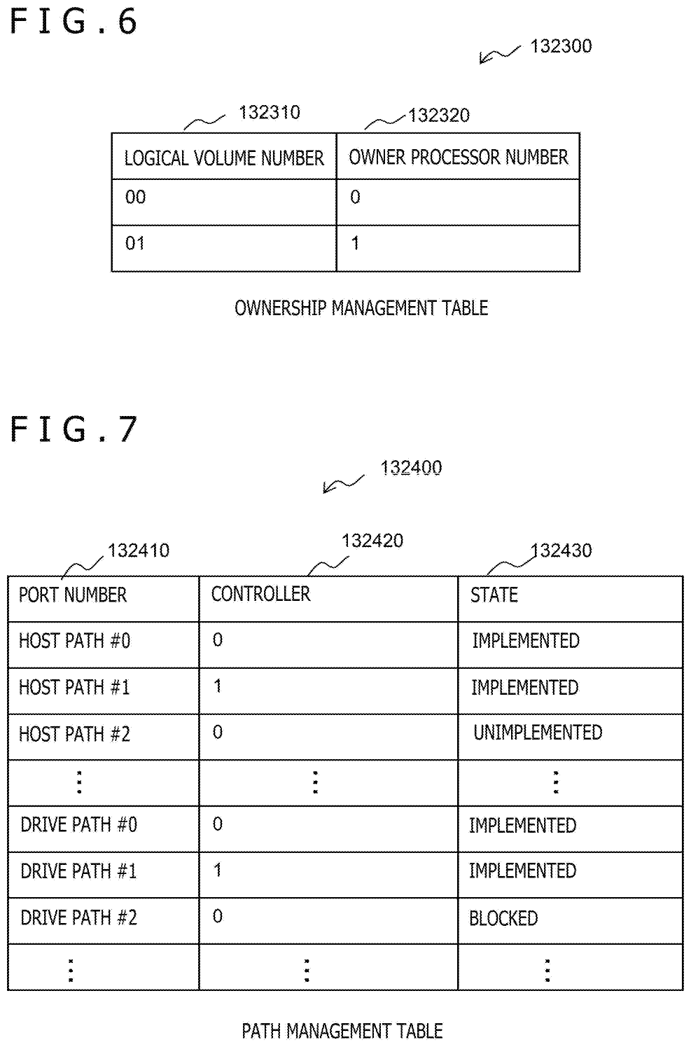

FIG. 6 is a figure illustrating a configuration example of the ownership management table 132300. The ownership management table 132300 associates a logical volume number 132310 and an owner processor number 132320 with each other. The logical volume number 132310 indicates a number for identifying a logical volume. The owner processor number 132320 indicates an owner processor number. By using the ownership management table 132300, an owner processor number of a logical volume can be identified from a logical volume.

FIG. 7 is a figure illustrating a configuration example of the path management table 132400. The path management table 132400 associates a port number 132410, a controller 132420 and a state 132430 with each other. The port number 132410 indicates a number for identifying a host path or a drive path. The controller 132420 indicates which controller the host path or drive path belongs to, and the state 132430 indicates whether the host path or drive path is being implemented, unimplemented or blocked. By using the path management table 132400, it is possible to check which controller each host path and drive path belongs to, and whether each host path and drive path is available.

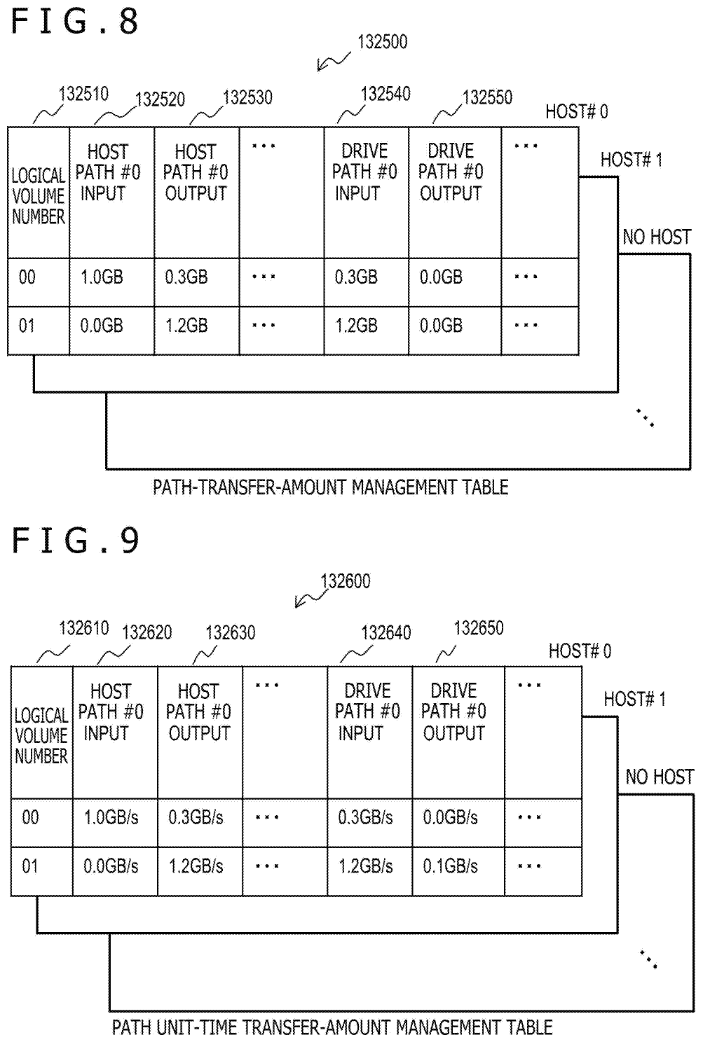

FIG. 8 is a figure illustrating a configuration example of the path-transfer-amount management table 132500. The path-transfer-amount management table 132500 associates the host computer 200000, a logical volume number 132510, an inflow amount 132520 and an outflow amount 132530 of each host path, and an inflow amount 132540 and an outflow amount 132550 of each drive path, with each other.

Moreover, there is a table (not illustrated) for tabulating data amounts of data transfer asynchronous with I/O to and from the host computer 200000. Data transfer asynchronous with I/O to and from the host computer 200000 includes, for example, data transfer for asynchronous destaging processes, data copy for replication, rebalancing for inter-drive capacity levelling, and the like.

The logical volume number 132510 indicates a number for identifying a logical volume. The inflow amount 132520 of a host path indicates the transfer amount of data having flowed from a host to a controller from a certain time point to the current time point. The outflow amount 132530 of a host path indicates the transfer amount of data having flowed from a controller to a host computer from a certain time point to the current time point.

The inflow amount 132540 of a drive path indicates the transfer amount of data having flowed from a drive to a controller from a certain time point to the current time point. The outflow amount 132550 of a drive path indicates the transfer amount of data having flowed from a controller to a drive from a certain time point to the current time point. By using the path-transfer-amount management table 132500, it is possible to calculate a host path data transfer amount and a drive-path data transfer amount for each logical volume in each host computer from a certain time point until the current time point appropriately.

FIG. 9 is a figure illustrating a configuration example of the path unit-time transfer-amount management table 132600. The path unit-time transfer-amount management table 132600 associates a logical volume number 132610, an inflow amount 132620 and an outflow amount 132630 of each host path, and an inflow amount 132640 and an outflow amount 132650 of each drive path, with each other.

The logical volume number 132610 indicates a number for identifying a logical volume. The inflow amount 132620 of a host path indicates the transfer amount of data to flow from a host to a controller per unit time. The outflow amount 132630 of a host path indicates the transfer amount of data to flow from a controller to a host computer per unit time. The inflow amount 132640 of a drive path indicates the transfer amount of data to flow from a drive to a controller per unit time. The outflow amount 132650 of a drive path indicates the transfer amount of data to flow from a controller to a drive per unit time.

By using the path unit-time transfer-amount management table 132600, it is possible to calculate a host path data transfer amount and a drive-path data transfer amount for each logical volume in each host computer per unit time. The path unit-time transfer-amount management table 132600 is generated from data of the path-transfer-amount management table 132500. The path unit-time transfer-amount management table 132600 may store unit-time transfer amounts of a time period corresponding to only one generation or may store unit-time transfer amounts of a time period corresponding to a plurality of generations.

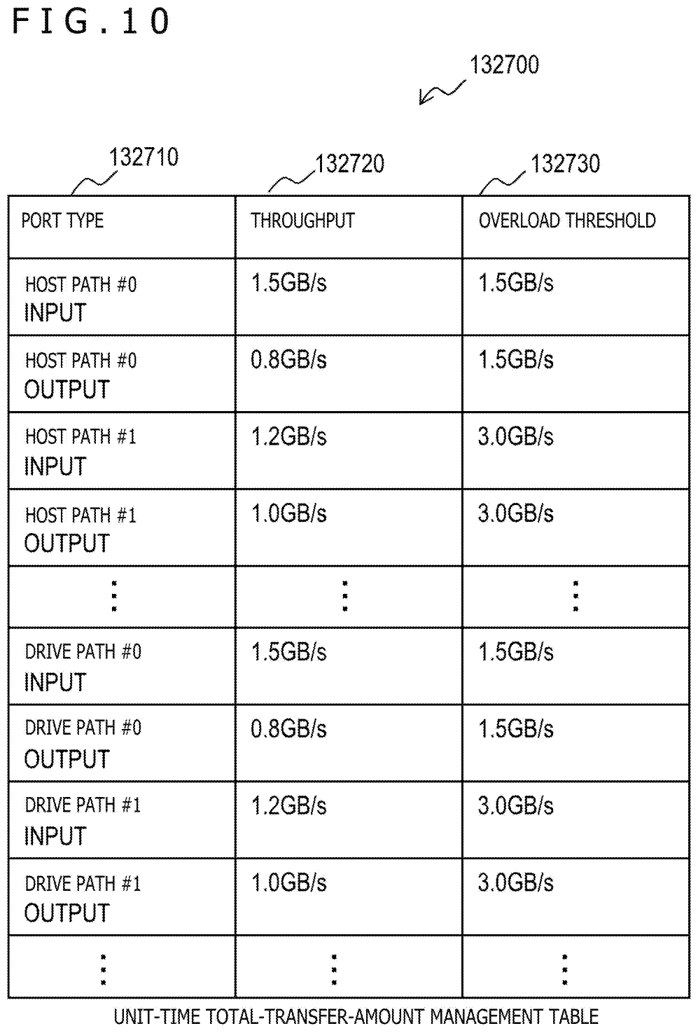

FIG. 10 is a figure illustrating the configuration of the unit-time total-transfer-amount management table 132700. The unit-time total-transfer-amount management table 132700 associates a port type 132710, a throughput 132720 and an overload threshold 132730 with each other. The port type 132710 indicates a type of a combination of a host path/drive path, a port number and a transfer direction. The overload threshold 132730 indicates, for each port type, a threshold for determination of an overload in which a transfer amount per unit time is large. The threshold may be set by a manager through the managing terminal 300000 or may be set automatically on the basis of the configuration information and operational information of the entire storage system 100000.

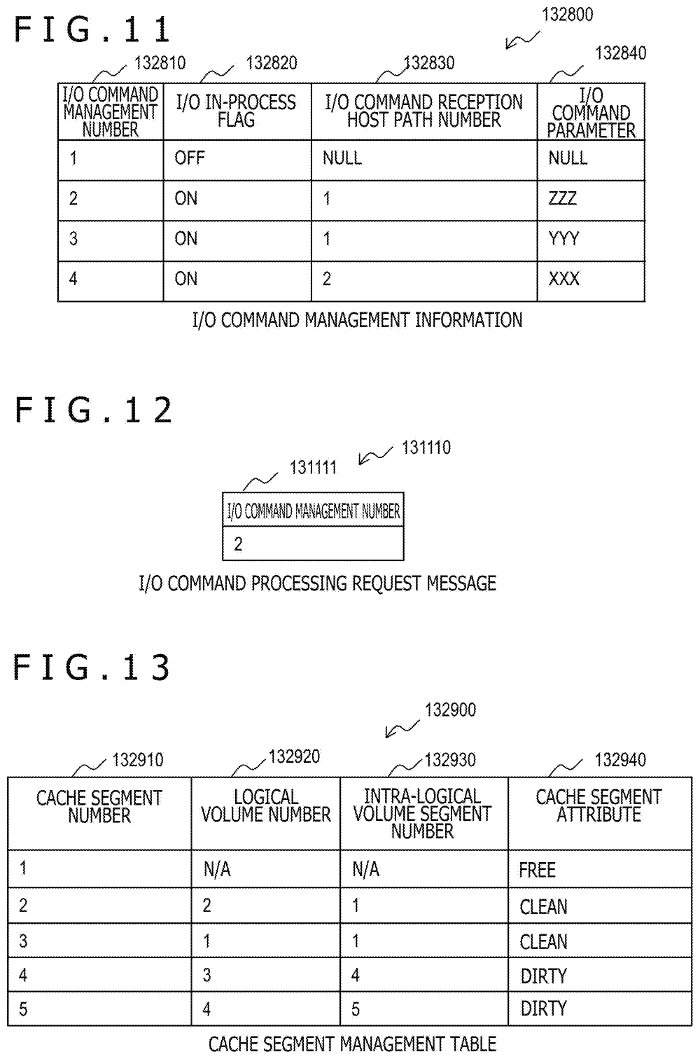

FIG. 11 is a figure illustrating a configuration example of the I/O command management table 132800. The I/O command management table 132800 associates an I/O command management number 132810, an I/O in-process flag 132820, an I/O command reception host path number 132830 and an I/O command parameter 132840 with each other. The I/O command management table 132800 indicates the state of execution of an I/O process in each processor, and specifically performs management in terms of how much I/O is being processed in each processor, and which FE ports has been used to receive I/O processes.

FIG. 12 is a figure illustrating a configuration example of an I/O command processing request message 131110. The I/O command processing request message 131110 indicates an I/O command management number 131111, which is used for communication between the processor 120000 that executes the command assignment processing program 131100 and a processor that executes the I/O-processing program 131200. These specific processes are mentioned below by using flowcharts.

FIG. 13 is a figure illustrating a configuration example of the cache segment management table 132900. The cache segment management table 132900 associates a cache segment number 132910, a logical volume number 132920, an intra-logical volume segment number 132930 and a cache segment attribute 132940 with each other.

The cache segment number 132910 indicates a value for identifying a cache segment 133100 on the cache memory area 133000. The logical volume number 132920 and the intra-logical volume segment number 132930 indicate which logical volume and which address in the logical volume the data stored in a cache segment having the cache segment number 132910 belongs to. The intra-logical volume segment number 132930 indicates an identification number that is obtained by splitting an intra-logical volume address in the unit of cache segments.

The cache segment attribute 132940 indicates the state of the cache segment having the cache segment number 132910. Clean indicates a state in which data on the cache segment has already been stored in a drive. Dirty indicates a state in which data on the cache segment has not been stored in a drive. Free indicates a state in which the cache segment is allocated to none of logical volumes and none of segments in the logical volumes.

By using the cache segment management table 132900, it is possible to determine which logical volume and which address in the logical volume the data stored in a cache segment belongs to, and determine whether or not the data has already been stored in a drive. Other than the cache segment management table 132900, the storage system 100000 may have a cache directory or the like for searching fast whether or not data belonging to a logical volume and an intra-logical volume segment is stored in a cache segment.

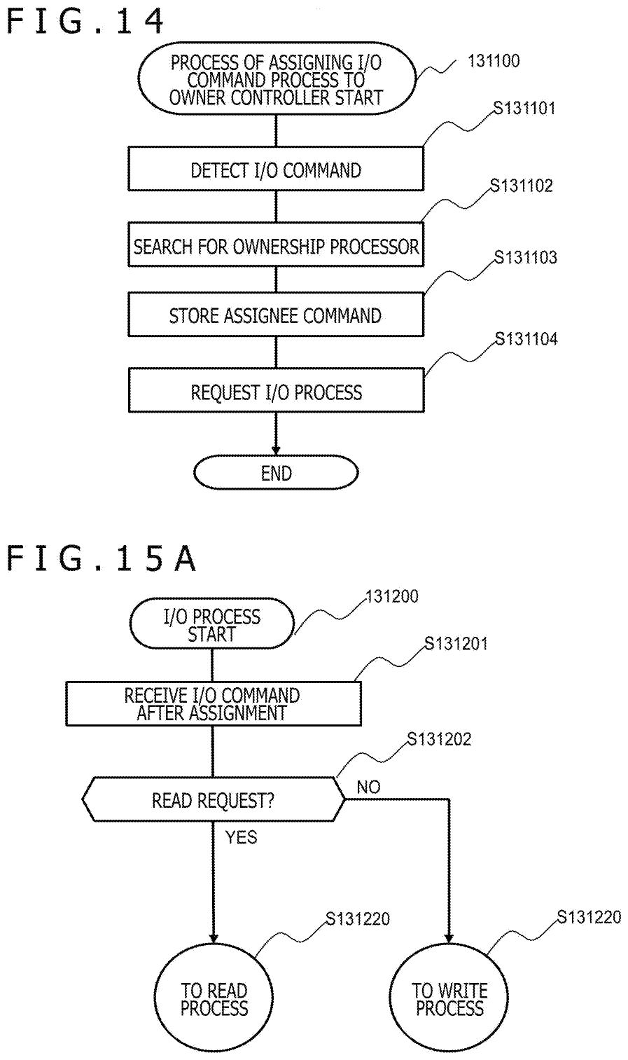

FIG. 14 is a flowchart of a process executed by the command assignment processing program 131100. First, from the host computer 200000, through a host interface 140000 connected to any of the controllers, an I/O command is registered in a memory 130000 on the controller to which the host interface 140000 is connected. At Step 131101, the command assignment processing program 131100 executed on a processor 120000 of the controller detects the registration of the I/O command, and proceeds to Step 131102.

At Step 131102, the command assignment processing program 131100 identifies an I/O-process responsible processor of an access-target logical volume from I/O owner processor numbers 132320 in the ownership management table 132300, and proceeds to Step 131103.

At Step 131103, the command assignment processing program 131100 searches for an unused I/O command management number 132810 in the I/O command management table 132800 on a memory of a controller including the I/O-process responsible processor. The configuration of each controller is stored in management information, which is not illustrated. The command assignment processing program 131100 rewrites an I/O in-process flag 132820 corresponding to the I/O command management number that is found through the search, such that the I/O in-process flag 132820 indicates “ON.” The command assignment processing program 131100 updates an I/O command reception host path number 132830 and an I/O command parameter 132840 corresponding to the I/O command management number, and proceeds to Step 131104.

At Step 131104, the command assignment processing program 131100 sends an I/O command processing request message 131110 indicating the I/O command management number to the memory of the controller including the I/O-process responsible processor, and ends the I/O command assignment process.

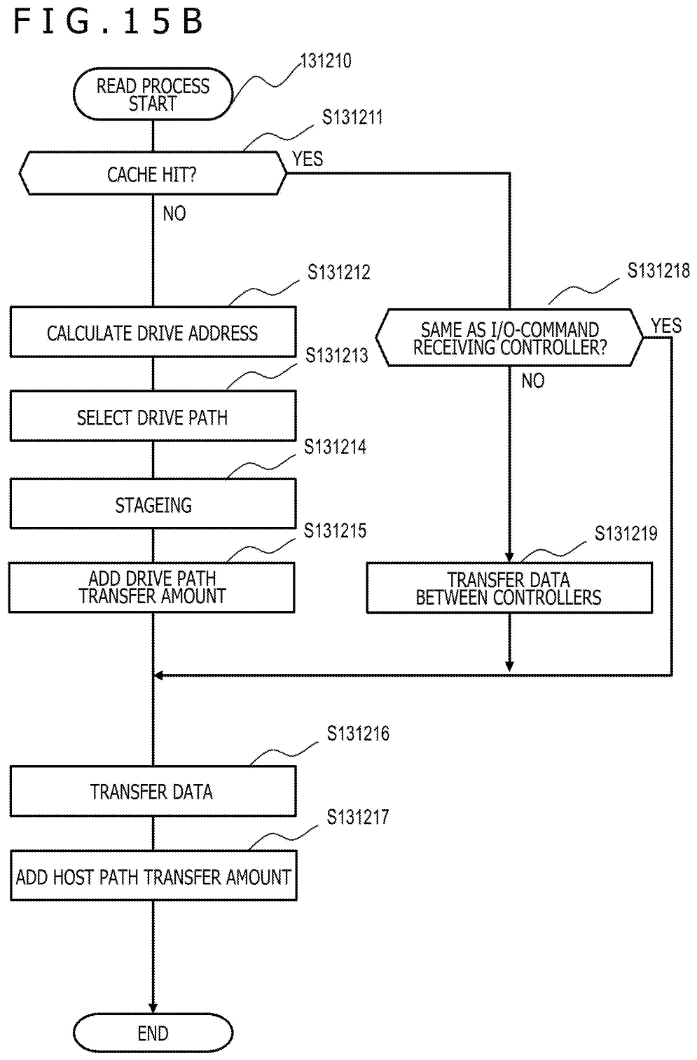

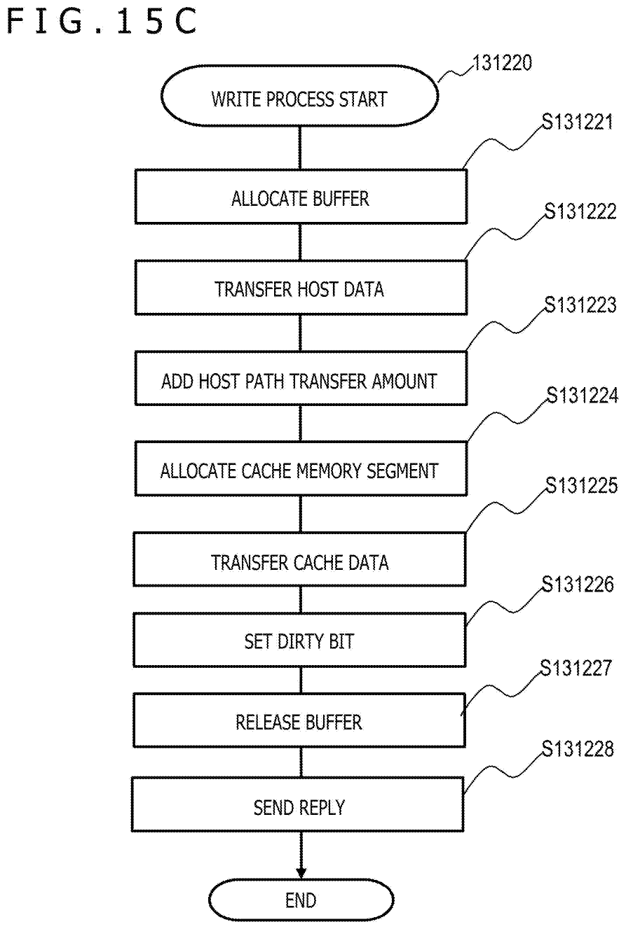

FIG. 15A, FIG. 15B and FIG. 15C are flowcharts of a process executed by the I/O-processing program 131200. FIG. 15A illustrates the beginning of a host I/O request process, FIG. 15B illustrates a read process and FIG. 15C illustrates a write process.

At Step 131201, the I/O-processing program 131200 executed by the I/O-process responsible processor having received the I/O command processing request message 131110 detects an I/O command assigned by the command assignment processing program 131100.

At Step 131202, the I/O-processing program 131200 determines from the I/O command whether the requested process is a read process or a write process. In a case where the requested process is a read process (131202: YES), the I/O-processing program 131200 proceeds to Step 131210, and in a case where the requested process is a write process (131202: NO), the I/O-processing program 131200 proceeds to Step 131220.

The read process 131210 is explained first. At Step 131211, the I/O-processing program 131200 determines whether or not there is access-target data on a cache segment (whether or not a cache hit occurs) by using the cache segment management table 132900 or the cache directory. In a case where there is not the target data on cache segments (131211: NO), the I/O-processing program 131200 proceeds to Step 131212. In a case where there is the target data on a cache segment (131211: YES), the I/O-processing program 131200 proceeds to Step 131218.

At Step 131212, the I/O-processing program 131200 refers to the logical-volume-address management table 132100, identifies a drive number 132130 and an intra-drive address 132140 corresponding to an access-target logical volume number 132110 and intra-logical volume address 132120, and proceeds to Step 131213.

At Step 131213, the I/O-processing program 131200 acquires a drive path number for transferring data in a drive to the memory 130000 of the controller. At that time, to avoid occurrence of inter-controller data transfer, the I/O-processing program 131200 acquires, from the I/O command management table 132800, the host path number 132830 of a host path through which the I/O has been received, and selects, from the path management table 132400, a drive path number (port number) 132410 of the controller that has received the I/O. In a case where there are a plurality of drive paths, the I/O-processing program 131200 selects a drive path by round robin selection or the like such that there will not be an imbalance of loads on drive paths.

Next, the I/O-processing program 131200 proceeds to Step 131214. At Step 131214, the I/O-processing program 131200 reserves a data buffer area 134100 in a data transfer buffer area 134000 in the controller to which the selected drive path number (port number) 132410 belongs, for staging data from the drive. The I/O-processing program 131200 reads out data in the drive number 132130 and the intra-drive address 132140, stores the data in the reserved data buffer area 134100, and proceeds to Step 131215.

At Step 131215, the I/O-processing program 131200 adds the amount of the data transferred for the staging to a drive path INPUT transfer amount 132540 corresponding to the accessed logical volume number 132110 in the path-transfer-amount management table 132500. The I/O-processing program 131200 proceeds to Step 131216.

At Step 131216, the I/O-processing program 131200 uses the host interface 140000 to transfer the target data from the data buffer area 134100 to the host computer 200000, and proceeds to Step 131217.

At Step 131217, the I/O-processing program 131200 adds the transfer amount of the data transferred to the host computer 200000 in the path-transfer-amount management table 132500. Specifically, the I/O-processing program 131200 searches logical volume numbers 132510 for the logical volume number, adds the transfer amount to an OUTPUT transfer amount 132530 of the corresponding host path number, and ends the read process.

At Step 131218, the I/O-processing program 131200 determines whether there is a cache segment number 132910 for which the cache hit occurred on the memory of the controller that has received the I/O command from the host computer 200000. In a case where there is the cache segment number 132910 on the memory, the I/O-processing program 131200 proceeds to Step 131216. At Step 131216, the I/O-processing program 131200 uses a cache segment 133100 instead of a data buffer area 134100, and transfers the data to the host.

In a case where there is not the cache segment number 132910 for which the cache hit occurred on the memory of the controller that has received the I/O command from the host computer 200000, the I/O-processing program 131200 proceeds to Step 131219. At Step 131219, the I/O-processing program 131200 reserves a data buffer area 134100 in a data transfer buffer area 134000 in the controller that has received the I/O command from the host computer 200000, and transfers the data from a cache segment to the reserved data buffer. Thereafter, the flow proceeds to Step 131216.

Next, the write process is explained. At Step 131221, the I/O-processing program 131200 reserves a data buffer area 134100 for storage of write data from the host computer 200000 on the memory 130000 of the controller that is the host path through which the I/O command has been received, and proceeds to Step 131222.

At Step 131222, the I/O-processing program 131200 requests the host computer 200000 to transfer the write data, transfers the write data to the data buffer area 134100, and proceeds to Step 131223.

At Step 131223, the I/O-processing program 131200 adds the transfer amount of the data transferred from the host computer 200000 in the path-transfer-amount management table 132500. Specifically, the I/O-processing program 131200 searches logical volume numbers 132510 for the logical volume number, and adds the transfer amount to an INPUT transfer amount 132520 of the corresponding host path number. Next, the I/O-processing program 131200 proceeds to Step 131224.

At Step 131224, the I/O-processing program 131200 reserves a cache segment 133100 in each of two controllers in order to duplicate the write data in the cache memory areas 133000 between the controllers, and keeps the data protected until the write data is stored in the drive. From the cache segment management table 132900, the I/O-processing program 131200 selects a record whose cache segment attribute 132940 is free, and registers a write-target logical volume number 132920 and intra-logical volume segment number 132930. Next, the I/O-processing program 131200 proceeds to Step 131225.

At Step 131225, the I/O-processing program 131200 transfers the write data from the data buffer area 134100 storing the data to the two reserved cache segments 133100. Data before being destaged to a drive is referred to as dirty data. Next, the I/O-processing program 131200 proceeds to Step 131226.

At Step 131226, the I/O-processing program 131200 updates the slot status corresponding to the segment number in the cache segment management table 132900 to dirty, and proceeds to Step 131227. At Step 131227, the I/O-processing program 131200 releases the data buffer area 134100.

Thereafter, the I/O-processing program 131200 proceeds to Step 131228, sends Good status to the host computer 200000, and completes the write process. The dirty data on the cache segments is destaged to the drive asynchronously with the I/O process. The data may be stored redundantly in a plurality of drives forming a RAID group.

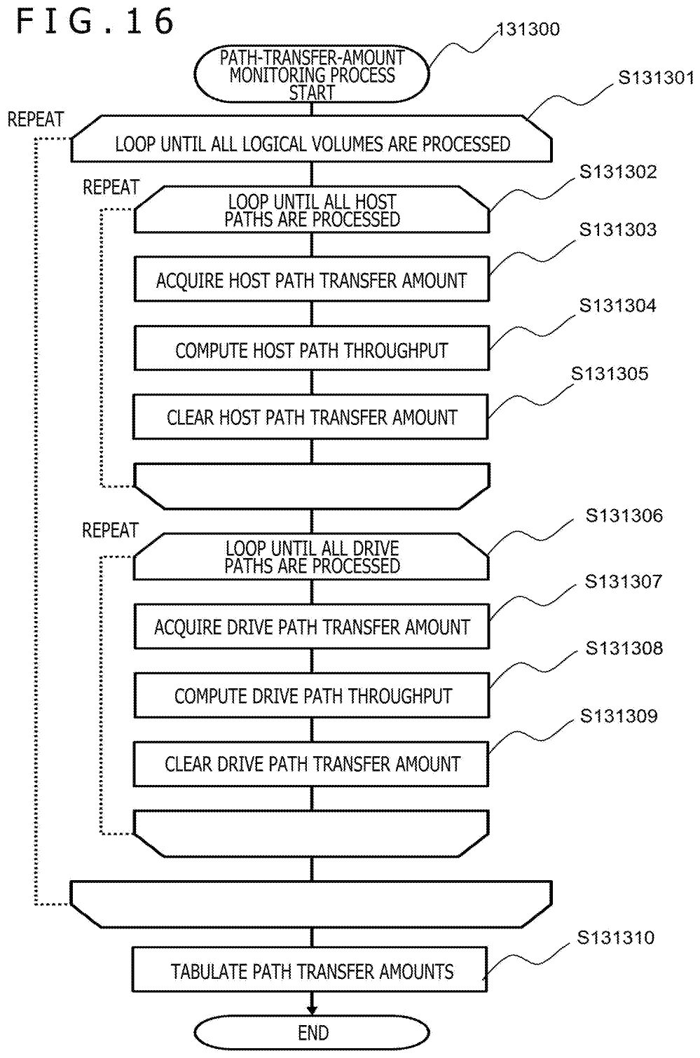

FIG. 16 is a flowchart of a process executed by the path-transfer-amount monitoring program 131300. The path-transfer-amount monitoring program 131300 is activated at predetermined intervals, and computes the transfer amount of each host path and drive path per unit time.

At Step 131301, the path-transfer-amount monitoring program 131300 performs repetitive determinations about logical volumes. The path-transfer-amount monitoring program 131300 determines whether Step 131302 to Step 131309 have been executed on all the logical volumes implemented in the storage system 100000. If the steps have already been executed, the path-transfer-amount monitoring program 131300 exits the repetitive process, and proceeds to Step 131310. If there are one or more logical volumes on which the steps have not been executed, the path-transfer-amount monitoring program 131300 selects one of the logical volumes for which the steps have not been executed, and proceeds to Step 131302.

At Step 131302, the path-transfer-amount monitoring program 131300 performs repetitive determinations about host paths. The path-transfer-amount monitoring program 131300 determines whether Step 131303 to Step 131305 have been executed on all the host paths implemented in the storage system 100000. If the steps have already been executed, the path-transfer-amount monitoring program 131300 exits the repetitive process, and proceeds to Step 131306. If there are one or more host paths on which the steps have not been executed, the path-transfer-amount monitoring program 131300 selects one of the host paths for which the steps have not been executed, and proceeds to Step 131303.

At Step 131303, for each host computer (and for the case without host computers), the path-transfer-amount monitoring program 131300 acquires INPUT and OUTPUT data transfer amounts corresponding to the selected logical volume and the selected host path from the path-transfer-amount management table 132500. Next, the path-transfer-amount monitoring program 131300 proceeds to Step 131304.

At Step 131304, the path-transfer-amount monitoring program 131300 divides the acquired INPUT and OUTPUT data transfer amounts by an execution interval of the path-transfer-amount monitoring program 131300, and calculates, for each host, INPUT and OUTPUT transfer amounts per unit time. The path-transfer-amount monitoring program 131300 writes the results of the computation in the path unit-time transfer-amount management table 132600. Next, the path-transfer-amount monitoring program 131300 proceeds to Step 131305.

At Step 131305, for each server (and for the case without servers), the path-transfer-amount monitoring program 131300 clears INPUT and OUTPUT transfer amounts corresponding to the target logical volume and host path in the path-transfer-amount management table 132500, and returns to Step 131302.

From Step 131306 to Step 131309, the path-transfer-amount monitoring program 131300 executes, for drive paths, processes similar to the processes executed for host paths at Step 131302 to Step 131305. When the processes for all the drive paths end, the path-transfer-amount monitoring program 131300 returns to Step 131301.

At Step 131310, the path-transfer-amount monitoring program 131300 totals the INPUT and OUTPUT transfer amounts of each host path and drive path per unit time for all the logical volumes and host computers (and for the case without host computers), and writes the total value in a throughput 132720 in the unit-time total-transfer-amount management table 132700.

By using the path-transfer-amount monitoring program 131300, it is possible to know which host path and drive path each host computer uses for a logical volume, how much the host computer accesses the logical volume, and the total transfer amount per unit time of each host path and drive path.

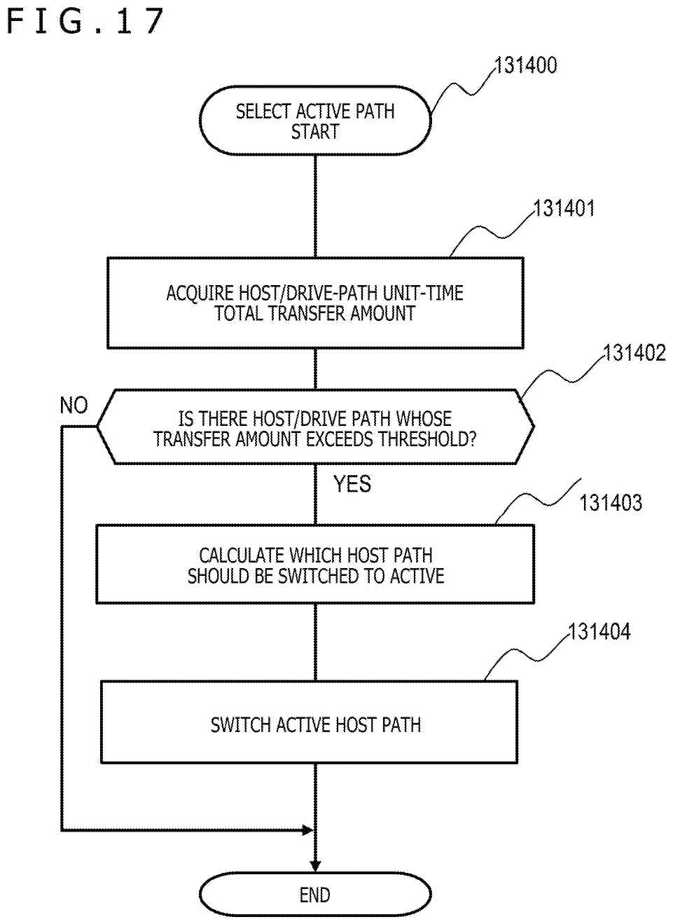

FIG. 17 is a flowchart of processes executed by the priority-host-path selection program 131400. The priority-host-path selection program 131400 is activated at predetermined intervals, determines the load statuses of host paths and drive paths for each logical volume, and decides the host path priority for each host such that there will not be overloaded paths.

At Step 131401, the priority-host-path selection program 131400 refers to the throughput of each host path and drive path in the unit-time total-transfer-amount management table 132700, and proceeds to Step 131402.

At Step 131402, the priority-host-path selection program 131400 determines whether the transfer amount (throughput) of each host and drive path does not exceed a corresponding overload threshold 132730. In a case where there is a path whose transfer amount exceeds the overload threshold (131402: YES), the priority-host-path selection program 131400 proceeds to Step 131403. In a case where there are no paths whose transfer amounts exceed the thresholds (131402: NO), the priority-host-path selection program 131400 ends the process. By changing the host path priority in a case where there is a path whose transfer amount exceeds the overload threshold, it is possible to appropriately avoid deterioration of the performance of the storage system caused by an occurrence of bottleneck.

At Step 131403, the priority-host-path selection program 131400 refers to the path unit-time transfer-amount management table 132600, and determines, through calculation, a host computer and a logical volume of the host computer whose host paths need to have different attributes in order for transfer amounts to be not greater than the threshold. At this time, paths whose states are not defined or which are unavailable in the host-path-priority management table 132200 are not used.

In one example case, in the path priority setting of the combination of a host computer number 1 and a logical volume number 0, the priority of a host path number 0 is Active, and the priority of a host path number 1 is Passive. The combination of the host path number 0 and a drive path number 0, and the combination of the host path number 1 and a drive path number 1 each form one path between the host computer number 1 and the logical volume number 0.

In one case, the path unit-time transfer-amount management table 132600 indicates that the inflow amount of the host path number 0 is 100 MB/s, the outflow amount of the host path number 0 is 300 MB/s, the inflow amount of the drive path number 0 is 0 MB/s, and the outflow amount of the drive path number 0 is 300 MB/s. The transfer amounts of the host path number 1 and the drive path number 1 for the logical volume number 0 are 0.

When the Active path and the Passive path are switched between the host path number 0 and the host path number 1, a change of the transfer amount of each path can be computed for the transfer amounts in the unit-time total-transfer-amount management table 132700 in the following manner. 100 MB/s is subtracted from the inflow amount of the host path number 0, 300 MB/s is subtracted from the outflow amount of the host path number 0, and 300 MB/s is subtracted from the outflow amount of the drive path number 0. Furthermore, 100 MB/s is added to the inflow amount of the host path number 1, 300 MB/s is added to the outflow amount of the host path number 1, and 300 MB/s is added to the outflow amount of the drive path number 1.

For example, the priority-host-path selection program 131400 sequentially selects host paths and drive paths whose transfer amounts exceed the overload thresholds, and changes the host path priority corresponding to each selected host path and drive path such that the transfer amount of the path becomes equal to or lower than the overload threshold or is minimized, only to the extent that such a change of the host path priority does not make the transfer amount of another path greater than the overload threshold.

To facilitate levelling among the paths, for example, the priority-host-path selection program 131400 may determine a change that minimizes the variation of the ratio of the transfer amount of each path per unit time to the overload threshold of the path. For the calculation, all the combination patterns may be searched or a mathematical solution may be used for a combinatorial optimization problem. In addition, in a case where there are no combinations that make transfer amounts not greater than the overload thresholds, the priority-host-path selection program 131400 may select a combination that minimizes the ratio of the transfer amount of each path per unit time to the overload threshold of the path.

The priority-host-path selection program 131400 may prioritize selection of a host path of a controller having ownership among a plurality of host paths of a logical volume. Thereby, the load on the storage system can be reduced. For example, in a case where a plurality of host paths can be selected for a combination of a host computer and a logical volume in a condition in which the transfer amounts of all the paths become equal to or lower than the overload thresholds, a host path of a controller having ownership is selected.

The priority-host-path selection program 131400 stores a selected host-path-priority combination in the host-path-priority management table 132200. In a case where results of monitoring of each unit-time transfer amount are stored for a plurality of generations (for a plurality of intervals), a value obtained by taking a weighted average of the generations by using preset weights may be compared with overload thresholds, to make it possible to avoid increased frequency of switching of the host path priority, and avoid unstable performance due to increase of processing costs caused by the switching. The way to determine the host path priority is not limited to the optimization method described here.

Next, the priority-host-path selection program 131400 proceeds to Step 131404. At Step 131404, the priority-host-path selection program 131400 notifies each host computer 200000 of the host path priority updated at Step 131403, and ends the process.

In a case where the frequency of changes of the host path priority (the frequency of transfer amounts exceeding overload thresholds) exceeds a threshold, intervals of the activation of the priority-host-path selection program 131400 may be made longer by a predetermined length of time to lower the frequency of changes of the host path priority. Thereby, it is possible to reduce increase in the processing load due to changes of the priority. Note that the host path priority may be changed depending on condition different from the condition in which the transfer amount of any of paths exceeds a threshold (e.g. the host path priority may be changed at predetermined intervals).

As mentioned above, according to the present embodiment, by estimating the transfer amounts of host paths and drive paths resulting from the change of the priority of the host paths in accordance with the loads on the host paths and the drive paths, the priority of the host paths can be changed appropriately.

### Second Execution Example

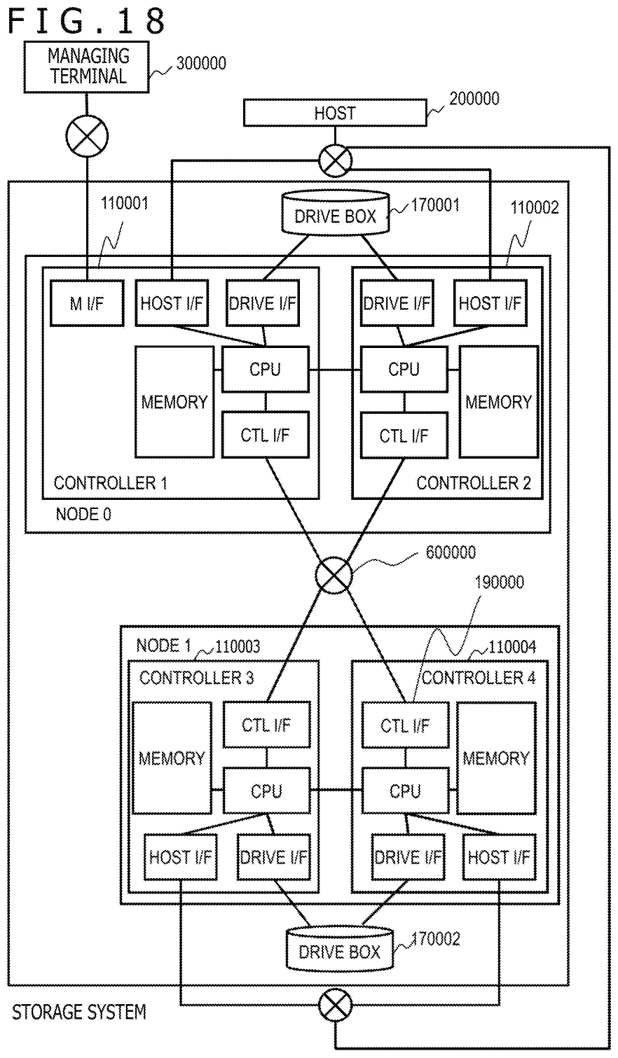

A second execution example is explained. The following description mainly explains differences from the first execution example, and unnecessary explanation of common portions to the first execution example is omitted. FIG. 18 is a figure illustrating a configuration example of the computer system in the second execution example. The storage system according to the second execution example includes an inter-controller network 600000 that connects controllers to each other, and controller interfaces 190000, and the number of connections of the controllers is expanded. Drive boxes are shared only by some controllers.

FIG. 18 illustrates four controllers 110001 to 110004, for example. A drive box 170001 is shared by the controllers 110001 and 110002, and a drive box 170002 is shared by the controllers 110003 and 110004.

In this configuration, in a case where data is transferred from a drive to a memory of a controller to which a drive path is not directly connected, it is necessary to transfer the data to a memory of a controller to which the drive is connected, and then transfer the data through controller interfaces 190000 and the inter-controller network 600000.

In this system, the drive path to be selected is changed depending on whether or not inter-controller data transfer becomes necessary when the host path to be used is switched. Accordingly, a computation method different from that in the first embodiment is used to compute how the inflow amount and outflow amount of each path will change when the host path priority is switched. Thereby, the transfer amounts of host paths and drive paths resulting from a change of the host path priority can be estimated appropriately.

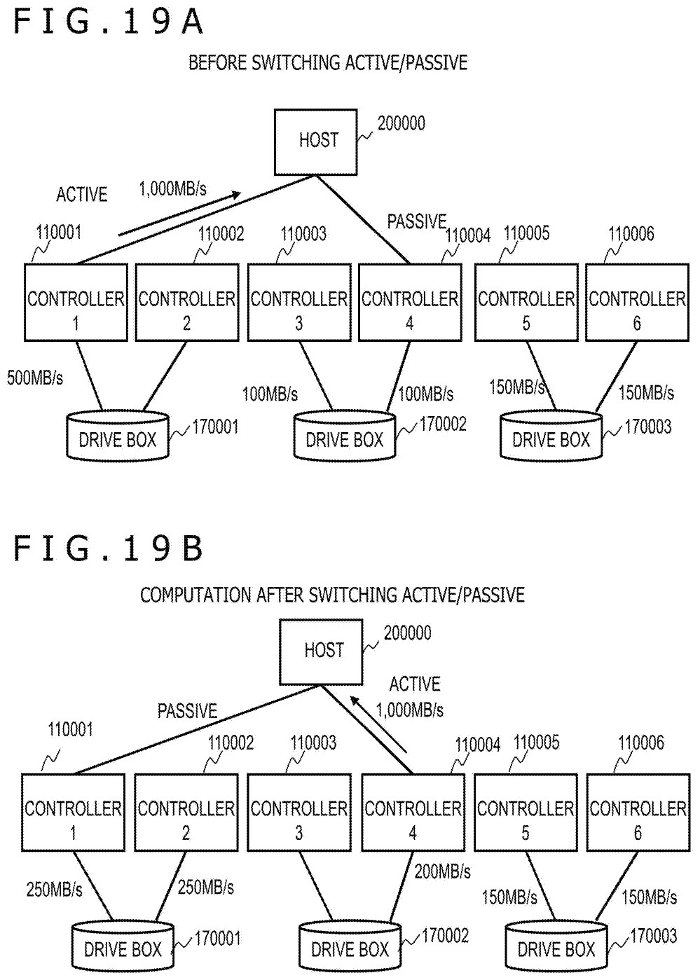

FIGS. 19A and 19B are figures illustrating one example of a computation method in the second execution example for predicting changes of data transfer amounts when the host path priority is changed. Six controllers 110001 to 110006 are connected to one host computer 200000. Drive boxes 170001 to 170003 are each shared by two controllers.

FIG. 19A illustrates the current transfer amount (throughput) of each path before the host path priority of a logical volume is switched. The priority of the host path of Controller 1 (110001) is set to Active, and the priority of the host path of Controller 4 (110004) is set to Passive.

Data can be transferred directly from the drive box (drive) connected to a controller 1 (110001) to the host computer 200000 through the controller 1 (110001). Accordingly, the transfer amount of the drive path of a controller 2 (110002) sharing the drive box 170001 with the controller 1 (110001) is 0 MB/s.

Data transfer from drive boxes connected to other controllers to the host computer 200000 necessarily requires inter-controller data transfer no matter which one of connected controllers is used. Accordingly, in the example illustrated in FIGS. 19A and 19B, the transfer amounts of two drive paths of one drive box are equal to each other. Note that the transfer amounts of drive paths of the same drive box that requires inter-controller data transfer are not necessarily equal to each other, but depend on an inter-controller path selection algorithm and the states of controllers.

FIG. 19B illustrates a computation method for a change of the transfer amount of each path in a case where the priority-host-path selection program 131400 switches the Active path and the Passive path when the priority-host-path selection program 131400 selects the host path priority at Step 131403. In one case, from the state illustrated in FIG. 19A, the priority of the path of a controller 4 (110004) is changed to Active, and the priority of the path of the controller 1 (110001) is changed to Passive.

The transfer amount of the host path of the controller 4 (110004) whose priority has been changed to Active is computed as 1000 MB/s, similarly to the host path of the controller 1 (110001) before the change. Data from the drive box 170002 connected to the controller 4 (110004) is transferred directly through the controller 4 (110004) to the host computer 200000. Accordingly, the transfer amount of the drive path of the controller 4 (110004) is computed as 200 MB/s, and the transfer amount of the drive path of a controller 3 (110003) is computed as 0 MB/s.

Inter-controller data transfer becomes necessary no matter which drive path is used for the controller 1 (110001) and the controller 2 (110002). Accordingly, the transfer amounts of the drive paths are both computed as 250 MB/s on the hypothesis that they are used evenly. Because the situation has not changed for a controller 5 (110005) and a controller 6 (110006) from before the change of the path priority, the transfer amounts are computed as being the same as those before the change.

In this manner, by computing the transfer amount of each path after switching, and adding the differences from values before the switching to throughputs in the unit-time total-transfer-amount management table, a change of the total transfer amount of each path can be obtained. The priority-host-path selection program 131400 executes this on combinations of each host computer and logical volumes, and searches for a host-path-priority combination that makes the transfer amounts not greater than the overload thresholds.

Note that the present invention is not limited to the embodiments described above, but includes various modification example. For example, the embodiments described above are explained in detail in order to explain the present invention in an easy-to-understand manner, and embodiments are not necessarily limited to the ones including all the configurations that are explained. In addition, a part of the configurations of an embodiment can be replaced with configurations of another embodiment, and also configurations of an embodiment can be added to the configurations of another embodiment. Further, for a part of the configurations of each embodiment, addition of or replacement with other configuration, or deletion may be possible.

Furthermore, the configurations, functions, processing sections and the like described above may be realized by hardware by designing some or all of them, for example, by an integrated circuit or by other means. In addition, the configurations, functions and the like described above may be realized by software by a processor interpreting and executing a program that realizes the functions. Information of programs, tables or files that realize the functions can be stored on a recording apparatus such as a memory, a hard disk or a solid state drive (SSD), or on a recording medium such as an integrated circuit (IC) card or an secure digital (SD) card.

In addition, only control lines and information lines that are considered to be necessary for explanation are illustrated, and they are not necessarily the only control lines and information lines necessary for a product. Actually, it may be considered that almost all the configurations are connected with each other.

What is claimed is:

1. A storage system that processes an I/O request from a host, the storage system comprising:
a plurality of controllers; and
a plurality of storage drives, wherein
the host and the plurality of controllers are connected to each other by a plurality of host paths,
the plurality of controllers and the plurality of storage drives are connected to each other by a plurality of drive paths,
a controller responsible for a logical volume processes an I/O request specifying the logical volume,
a host path and a drive path from the host to a storage drive including a physical storage area related to the logical volume are decided for the controller responsible for the logical volume, host path priority for the logical volume, and the storage drive,
the plurality of controllers
monitor a transfer amount of each path of the plurality of host paths and the plurality of drive paths in the logical volume,
estimate changes of the host path and the drive path after a change of the priority of the plurality of host paths and estimate the transfer amount of each path of the plurality of host paths and the plurality of drive paths after the change of the priority on a basis of the estimated changes of the host path and the drive path, and the monitored transfer amount of each path, and
change the priority of the plurality of host paths on a basis of the estimated transfer amount of each path such that the transfer amount of each path satisfies a predetermined condition.

2. The storage system according to claim 1, wherein
the plurality of controllers
monitor transfer amounts of the plurality of host paths and the plurality of drive paths; and
change the priority of the plurality of host paths in a case where a transfer amount of any path of the plurality of host paths and the plurality of drive paths exceeds a predetermined threshold.

3. The storage system according to claim 2, wherein
the plurality of controllers monitor transfer amounts of the plurality of host paths and the plurality of drive paths for each combination of a logical volume and a host computer.

4. The storage system according to claim 2, wherein
the plurality of controllers change the priority of the plurality of host paths such that the estimated transfer amount of each path of the plurality of host paths and the plurality of drive paths after the change of the priority of the plurality of host paths becomes equal to or lower than the threshold.

5. The storage system according to claim 2, wherein
the plurality of controllers change the priority of the plurality of host paths such that a variation of a difference between each path of the plurality of host paths and the plurality of drive paths and a corresponding threshold becomes small.

6. The storage system according to claim 2, wherein
the plurality of controllers retain a result of the monitoring of the transfer amounts of the plurality of host paths and the plurality of drive paths of a plurality of generations, and
a weighted average of the plurality of generations is compared with the threshold.

7. The storage system according to claim 1, wherein
at least some of the plurality of storage drives are shared by only some of the plurality of controllers, and
the plurality of controllers estimate the transfer amount of each path of the plurality of host paths and the plurality of drive paths after the change of the priority of the plurality of host paths in a condition in which inter-controller data transfer does not occur.

8. The storage system according to claim 1, wherein
the plurality of controllers raise host path priority of a controller having ownership in a plurality of host paths of a logical volume.

9. The storage system according to claim 1, wherein
a drive path of each of the plurality of storage drives is set for one or more particular controllers in the plurality of controllers.

10. A method of controlling a storage system that processes an I/O request from a host and that includes a plurality of controllers and a plurality of storage drives,
the host and the plurality of controllers being connected by a plurality of host paths,
the plurality of controllers and the plurality of storage drives being connected by a plurality of drive paths, the method comprising:
processing, by a controller responsible for a logical volume in the plurality of controllers, an I/O request specifying the logical volume, and deciding a host path and a drive path from the host to a storage drive including a physical storage area related to the logical volume for the controller responsible for the logical volume, host path priority for the logical volume, and the storage drive,
monitoring, by the plurality of controllers, a transfer amount of each path of the plurality of host paths and the plurality of drive paths in the logical volume;
estimating, by the plurality of controllers, changes of the host path and the drive path after a change of the priority of the plurality of host paths, and estimating the transfer amount of each path of the plurality of host paths and the plurality of drive paths after the change of the priority on a basis of the estimated changes of the host path and the drive path, and the monitored transfer amount of each path; and
changing, by the plurality of controllers, the priority of the plurality of host paths on a basis of the estimated transfer amount of each path such that the transfer amount of each path satisfies a predetermined condition.
